(19) United States
(12) Patent Application Publication
(10) Pub. No.: US 2011/0290416 A1
(43) Pub. Date: Dec. 1, 2011

(54) METHOD FOR IMPROVING THE FIREPROOFING PERFORMANCE OF VEHICLE BODY

(75) Inventors: BANGCHENG SUN, HEBEI (CN); GUOPING ZHANG, HEBEI (CN); LIRONG ZHANG, HEBEI (CN)

(73) Assignee: TANGSHAN RAILWAY VEHICLE CO., LTD., HEBEI (CN)

(21) Appl. No.: 13/174,443

(22) Filed: Jun. 30, 2011

Related U.S. Application Data
(63) Continuation of application No. PCT/CN2010/073523, filed on Jun. 3, 2010.

(30) Foreign Application Priority Data
May 31, 2010 (CN) 201010187271.4

(51) Int. Cl. B32B 38/08; G06F 17/50; B32B 38/00

(52) U.S. Cl. 156/280; 156/281; 703/1

(57) ABSTRACT

The present invention provides a method for improving the fireproofing performance of vehicle body, including: assuming a combustion position and hazards and defining a combustion damage area of vehicle body model according to 3D model and strength weak area of the vehicle body; calculating deflection of vehicle at a predefined high-temperature load charged onto the combustion damage area by using strength finite element; and judging whether the space between a suspension member under the vehicle and track surface can meet the requirement of travelling capacity under a safe speed after the vehicle is deflected according to the deflection of vehicle or not; if not, performing a fireproofing treatment to the combustion damage area of vehicle body. With little cost of calculation and non-metal materials, the present invention could improve strength performance of thermal load of the metal vehicle body, thus reducing the fire hazards and meeting the requirement of travelling capacity; in the case of any fire hazard, it's possible to win more time for evacuation and rescue, so as to guarantee the personnel safety and minimize the loss of properties.

### CROSS-REFERENCE TO RELATED APPLICATIONS

This application is a continuation of International Application No. PCT/CN2010/073523, filed on Jun. 3, 2010, which claims the priority benefit of China Patent Application No. 201010187271.4, filed on May 31, 2010. The contents of the above identified applications are incorporated herein by reference in their entirety.

### FIELD OF THE TECHNOLOGY

The present invention relates to a fireproofing technology of a high-speed vehicle body , and particularly to a method for improving the fireproofing performance of vehicles.

### BACKGROUND OF THE TECHNOLOGY

The fireproofing technology requirements for railway vehicles, motor train unit or metro products, such as TB/T3138-2006 Technical specification of flame retardant materials for rolling stock and the Regulations of the International Union of Railways of the UIC564-2 and UIC642, define the flame retardant property of non-metal materials, i.e. the method of measuring oxygen index of 450 combustion, which is used to mainly measure oxygen index, flame retardation and smoke density. However, the requirements for fireproofing performance cannot yet be met only based on these three indexes, in particular there is not any feasible basis for the fireproofing performance of metal vehicle body, that is to say, in prior art, in case an unexpected fire hazard is caused by non-metal materials in the vehicle body and a big fire is aroused instantaneously, the entire carriage or train will be burnt, which result to softening, deflection and collapse of the metal vehicle body and further affect the personnel evacuation and rescue operation. Therefore, the vehicle is lack of travelling capacity of safe speed.

On the whole, owing to higher requirements of high-speed trains (and vehicles) for the safety performance and reliability as well as their vulnerability to external and internal ambient factors, a feasible, preventive fireproofing measure and method for improving the fireproofing performance of metal vehicles shall be provided by the skilled person in prior art, so as to ensure safe driving and prevent occurrence of accidental fire hazards.

### SUMMARY

The technical solution of the present invention is to provide a method for improving the fireproofing performance of vehicle body to resolve the problems of prior art that in the event of insufficient strength of the vehicle body under thermal load conditions, the preventive fireproofing measure is able to retard the expansion of fire hazard to avoid the overburning of the entire vehicle within very short time, casualty and property loss arising from failure of evacuation in the case of the fire hazard caused by non-metal materials and electric parts in the vehicles.

In order to solve the above problem, the present invention discloses a method for improving the fireproofing performance of vehicle body, which including: assuming a combustion position and hazards and defining a combustion damage area of vehicle body model according to 3D model and strength weak area of the vehicle body; calculating deflection of vehicle at a predefined high-temperature load charged onto the combustion damage area by using strength finite element; and judging whether the space between a suspension member under the vehicle and track surface can meet the requirement of travelling capacity under a safe speed after the vehicle is deflected according to the deflection of vehicle or not; if not, performing a fireproofing treatment to the combustion damage area of vehicle body.

As a preferred option, the said method further includes the following steps executed repeatedly: modifying the 3D model of the vehicle body; and calculate deflection of vehicle at a predefined high-temperature load charged onto the combustion damage area by using strength finite element; and judging whether the space between a suspension member under the vehicle and track surface can meet the requirement of travelling capacity under a safe speed after the vehicle is deflected according to the deflection of vehicle or not; if yes, finishing the process, and if not, performing the fireproofing treatment to the combustion damage area of vehicle body.

As a preferred option, the manner of the performing the fireproofing treatment to the combustion damage area of vehicle body comprises: sticking non-metal fireproof material of heat expansion onto the combustion damage area of the vehicle body.

As a preferred option, the said method also includes brushing a layer of moistureproof paint onto the non-metal fireproof material of heat expansion.

As a preferred option, the range of predefined high-temperature is between 700° C.˜950° C.

As a preferred option, the travelling capacity under a safe speed is to travel at a speed of 40 km/h for 15 minutes.

As a preferred option, the vehicle body comprises the body of urban railway, subway, motor train unit, rolling stock and magnetic suspension.

As compared with prior art, the present invention has the following advantages:

With little cost of calculation and non-metal materials, the present invention could improve strength performance of thermal load of the metal vehicle body, thus reducing the fire hazards and meeting the requirement of travelling capacity; in the case of any fire hazard, it's possible to win more time for evacuation and rescue, so as to guarantee the personnel safety and minimize the loss of properties.

### BRIEF DESCRIPTION OF THE DRAWINGS

FIG. 1 is a flow process chart of an embodiment of the present invention of the method for improving the fireproofing performance of vehicle body;

FIG. 2 is a schematic view of a damage model of middle vehicles of the present invention;

FIG. 3-a is a curve graph of the relationship between aluminum alloy vehicle body's E-elastic modulus and temperature in the present invention;

FIG. 3-a is a curve graph of the relationship between aluminum alloy vehicle body's relative strength and temperature in the present invention.

### DETAILED DESCRIPTION OF THE PREFERRED EMBODIMENTS

In order to make the objects, technical solutions and merits of the present invention clearer, a further detailed description of embodiments of the present invention is given by reference to accompanying drawings

One of the core concept of the present invention is that: assuming the temperature of fire reach 700° C.˜950° C., the thermal load deflection of weakest point of static strength of the vehicle body is calculated to verify whether the softening, deflection and collapse of vehicle body arising from loss of strength and stiffness affect the implementation of evacuation, escape and rescue or not, and whether reliable travelling capacity within a certain period of time is available under safe speed or not. After calculation and verification, If the vehicle body cannot meet the requirement of fireproofing performance, i.e. travelling capacity, non-metal fireproof materials of heat expansion are attached to the weakest area of static strength of the vehicle body, so as to restrain the vehicle deflection arising from sharp temperature rise of the fire. Through calculation and verification, the vehicle body design can be modified several times until the fireproofing performance is met.

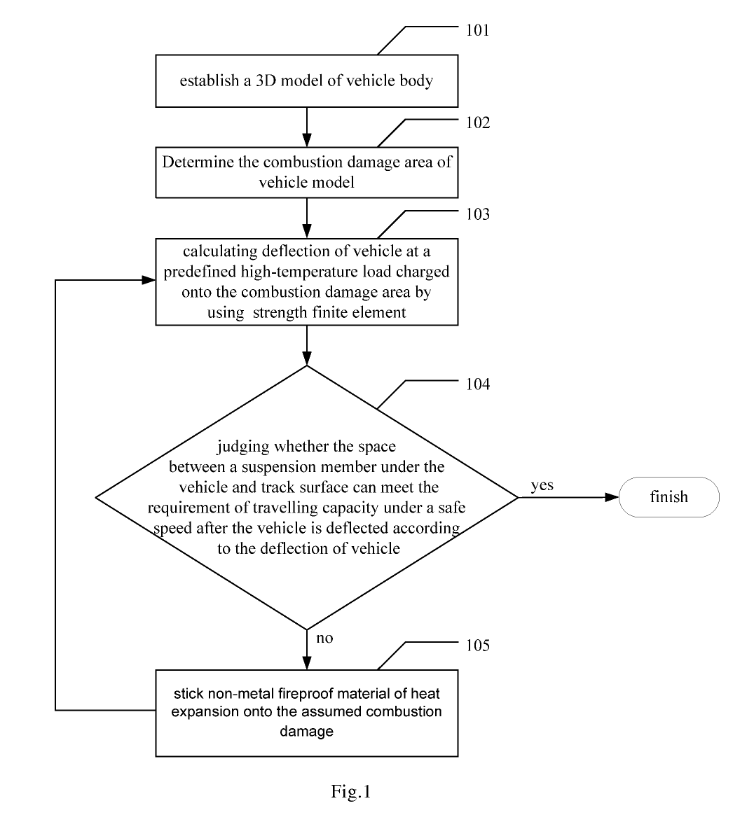

FIG. 1 illustrates a flow process chart of an embodiment of the present invention of the method for improving the fireproofing performance of vehicle body, which includes the following steps:

Step 101: establish a 3D model of vehicle body;

Step 102: assume the combustion area of fire;

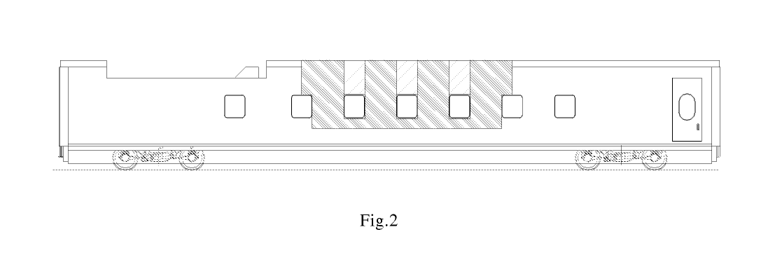

When the fire is fully developed, the ceiling temperature area could reach 700° C.˜950° C., the strength of material depends on temperature, and metal vehicle body will be gradually lost the strength with the temperature rise. In this preferred embodiment, three middle windows are assumed as combustion areas (i.e.: weak area of strength), and the 3D model of vehicle body is shown in FIG. 2, wherein the shadows represent the combustion areas.

Step 103: analyze the vehicle deflection by using strength finite element;

Step 104: use the calculated deflection to verify whether the space between the suspension member under the vehicle and track surface can meet the requirement of travelling capacity under a safe speed; if yes, finish the process; otherwise, proceed Step 105;

Step 105: stick non-metal fireproof material of heat expansion onto the assumed combustion damage area of the vehicle body, and modify the 3D model of the vehicle body; repeat Step 103 until meeting the predefined performance requirements.

In another preferred embodiment of the present invention, a layer of moistureproof paint is further brush after sticking non-metal fireproof material of heat expansion onto the area requiring reinforcement.

The following is a description based on aluminum alloy vehicle body:

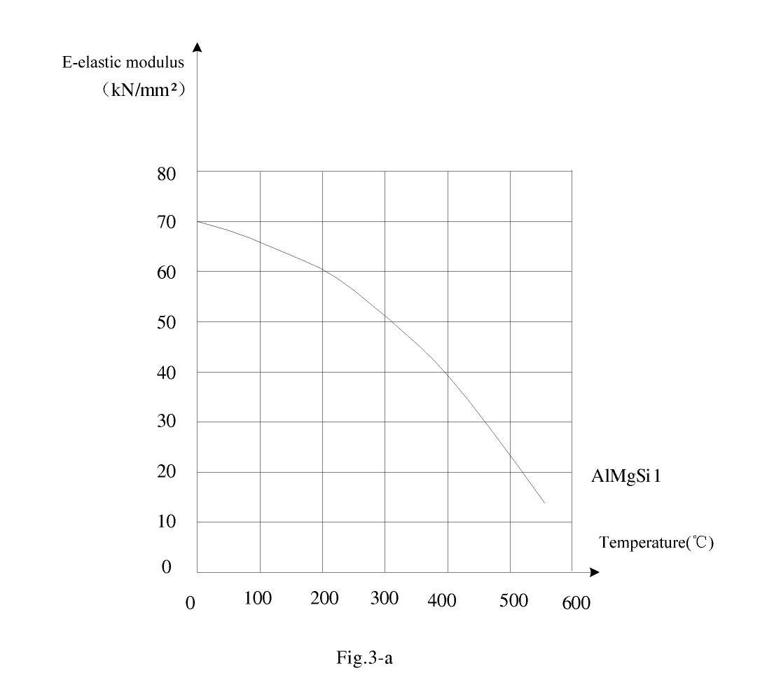

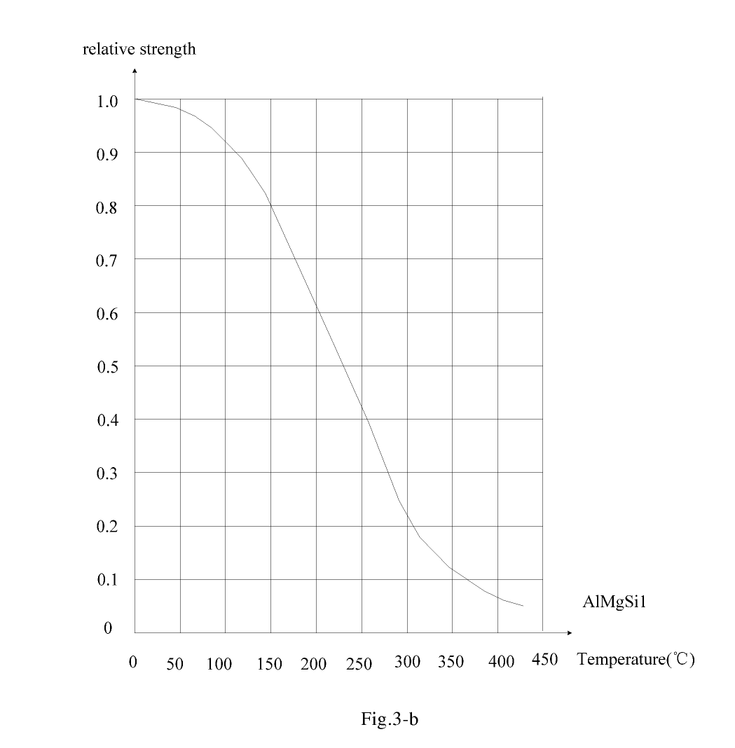

The vehicle body is made of AlMgSil-aluminum alloy, with the relationship between the temperature and relative strength shown in FIGS. 3-a and 3-b. It can be seen that, the relationship between AlMgSil aluminum alloy E-elastic modulus and temperature is significant; the strength of aluminum alloy will decline with temperature rise; the calculating parameters of the vehicle model can be determined according to the curve:

(1) When the temperature is higher than 300° C., aluminum alloy's elastic modulus drops abruptly, and the relative strength declines to zero;

(2) When the temperature ranges between 200° C. and 300° C., aluminum alloy's elastic modulus drops quickly, and the relative strength declines abruptly, with the strength taken in the case of 300° C.;

(3) When the temperature ranges between 100° C. and 200° C., aluminum alloy's elastic modulus drops slowly, and the relative strength declines quickly, with the strength taken in the case of 200° C.;

(4) When the temperature is lower than 100° C., aluminum alloy's elastic modulus and relative strength are in normal range.

In the strength design of the vehicle body available with travelling capacity in the case of big fire, only rupture strength is considered, rather than fatigue strength generally.

FIG. 2 illustrates a damage model of middle vehicles of the present invention, wherein it's assumed that the fire from the central hall of the carriage is spread to the width of 3 windows. The worst situation is at the bending moment along the length of the vehicle body, the weakest area begins from the window's lower edge and two lateral flanges to the next middle window, so the strength at 250 mm of the window's lower edge, both sides of enter door and top area of the entrance is weak.

After calculation of the weak area of strength, a layer of moistureproof paint is brushed after sticking non-metal fireproof material of heat expansion onto the area requiring reinforcement. Then, it's required to calculate again whether the requirement of travelling capacity is met, so as to ensure that motor train unit has a travelling capacity at 40 km/h for 15 minutes in fire (fully developed).

It's worthy to note that, the aforesaid preferred embodiments are described based on locomotives, but the present invention can also be applied to another vehicle, such as urban railway, subway, motor train unit, rolling stock and magnetic suspension.

For the purpose of description, the aforesaid preferred embodiments of the said method are represented as a combination of a series of operations, but it's well understood by those skilled person in the art that the present invention isn't restricted by the described operation sequence, since some steps can be implemented by other sequence or simultaneously according to the present invention. Also, it's understood that the aforesaid preferred embodiments of the said method belong to preferred options, so the associated operations and modules are not necessarily covered by the present invention.

The preferred embodiments herein are described in a progressive way, and the highlights of every preferred embodiment may differ from each other, so the equivalent or similar parts of every preferred embodiment may be referenced.

The above is a detailed description of improving the fireproofing performance of vehicles. It should be noted that the above embodiments are merely provided for describing the technical solutions of the present invention. The above embodiments is intended for providing a understanding of the method and core concept of the present invention; it should be appreciated that the present invention is capable of a variety of embodiments and various modifications by those skilled in the art. In a word, the specification should not be appreciated a limit of the present invention.

What is claimed is:

1. A method for improving the fireproofing performance of vehicle body, characterized in that it comprises:
assuming a combustion position and hazards and defining a combustion damage area of vehicle body model according to 3D model and strength weak area of the vehicle body;
calculating deflection of vehicle at a predefined high-temperature load charged onto the combustion damage area by using strength finite element; and
judging whether the space between a suspension member under the vehicle and track surface can meet the requirement of travelling capacity under a safe speed after the vehicle is deflected according to the deflection of vehicle or not; if not, performing a fireproofing treatment to the combustion damage area of vehicle body.

2. The method according to the claim 1, characterized in that it further comprises the following steps executed repeatedly:
modifying the 3D model of the vehicle body; and calculate deflection of vehicle at a predefined high-temperature load charged onto the combustion damage area by using strength finite element; and
judging whether the space between a suspension member under the vehicle and track surface can meet the requirement of travelling capacity under a safe speed after the vehicle is deflected according to the deflection of vehicle or not; if yes, finishing the process, and if not, performing the fireproofing treatment to the combustion damage area of vehicle body.

3. The method according to the claim 1, characterized in that the manner of the performing the fireproofing treatment to the combustion damage area of vehicle body comprises: sticking non-metal fireproof material of heat expansion onto the combustion damage area of the vehicle body.

4. The method according to the claim 3, characterized by brushing a layer of moistureproof paint onto the non-metal fireproof material of heat expansion.

5. The method according to the claim 1, characterized in that the range of predefined high-temperature is between 700° C.˜950° C.

6. The method according to the claim 1, characterized in that: the travelling capacity under a safe speed is to travel at a speed of 40 km/h for 15 minutes.

7. The method according to the claim 1, characterized in that the vehicle body comprises the body of urban railway, subway, motor train unit, rolling stock and magnetic suspension.
